(19) United States
(12) Patent Application Publication
(10) Pub. No.: US 2026/0235534 A1
(43) Pub. Date: Aug. 13, 2026

(54) NON-DESTRUCTIVE INSPECTION OF FILMS USING MILLIMETER-WAVE RADAR

(71) Applicant: Brigham Young University (BYU), Provo, UT (US)

(72) Inventor: Brian A. Mazzeo, Provo, UT (US)

(21) Appl. No.: 19/537,189

(22) Filed: Feb. 11, 2026

Related U.S. Application Data
(60) Provisional application No. 63/757,584, filed on Feb. 12, 2025.

(51) Int. Cl. G01N 22/02; G01N 21/892; G01S 7/41; G01S 13/86; G01S 13/89

(52) U.S. Cl. CPC G01N 22/02; G01N 21/892; G01S 7/41; G01S 13/865; G01S 13/89

(57) ABSTRACT

A system and method for characterizing a film, such as a lithium-ion battery electrode film, are disclosed. The system includes a millimeter-wave radar module that receives return signals from a plurality of test point on the film. Conductivity metrics for the plurality of test points are computed based on the return signals. A laser sensor can be included to measure a physical thickness of the film at the test points. By correlating a two-dimensional conductivity map derived from the conductivity metrics with a two-dimensional topological map derived from the thickness data, defects in the film's conductivity can be detected.

### CROSS REFERENCE TO RELATED APPLICATION

This application claims the benefit of U.S. Provisional Application No. 63/757,584, filed on Feb. 12, 2025, which is hereby incorporated by reference in its entirety.

### FIELD OF THE INVENTION

The present disclosure relates generally to non-destructive material characterization, and more particularly to systems and methods for inspecting thin, lossy, conductive films using scanning millimeter-wave (i.e., mmW) radar.

### BACKGROUND

Coatings (i.e., films) may be applied to substrates for various applications, such as transferring charge to a current collector in a lithium-ion battery. The quality of these thin films may be negatively affected by uneven mixing or drying. The heterogeneity caused by these uneven processes may be impossible to detect without destructive testing.

### SUMMARY

Systems and methods are disclosed for mapping electrical conductivity and thickness variations of thin films using non-destructive millimeter-wave radar scans.

In some aspects, the techniques described herein relate to a method including: directing a millimeter-wave radar module to a test point on a film deposited on a conductive substrate, the millimeter-wave radar module having a boresight direction at a transmission angle relative to a surface of the film; transmitting a transmit signal from the millimeter-wave radar module towards the test point; redirecting the transmit signal after it has passed through the film to generate a return signal; receiving the return signal at the millimeter-wave radar module; determining an attenuation of the return signal relative to the transmit signal; and computing a conductivity metric for the test point based on the attenuation of the return signal.

In a possible implementation, a plurality of conductivity metrics at a plurality of corresponding test points on the film may be collected by repositioning the millimeter-wave radar module between each collection, and the plurality of conductivity metrics may be rendered as a two-dimensional (i.e., 2D) map of conductivity.

In some aspects, the techniques described herein relate to a system including: a film disposed on a conductive substrate; a millimeter-wave radar module configured to: transmit a transmit signal towards the film, the transmit signal passing through the film at a test point and being redirected back to the millimeter-wave radar module as a return signal; and receive the return signal from the test point; a laser sensor configured to measure a thickness of the film at the test point; and a processor communicatively coupled to the millimeter-wave radar module and the laser sensor, the processor configured by software instructions to: determine an attenuation of the return signal relative to the transmit signal; and compute a conductivity metric for the test point based on the attenuation and the thickness of the film at the test point.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 is a schematic diagram of a lithium-ion battery with thin films according to a possible implementation of the present disclosure.

FIG. 2 is a schematic block diagram of a system for characterizing a film according to a possible implementation of the present disclosure.

FIG. 3 is a side-view of a scan with a transmission angle perpendicular to a surface of a film according to a possible implementation of the present disclosure.

FIG. 4 is a side view of a film, illustrating various measurements regarding the transmit signal and the return signal, according to a possible implementation of the present disclosure.

FIG. 5 is a graph illustrating how the conductivity metric relates to conductivity for different film thicknesses and for different frequencies according to possible implementations of the present disclosure.

FIG. 6 illustrates comparing a two-dimensional topological map and a two-dimensional conductivity map according to a possible implementation of the present disclosure.

FIG. 7 is a side-view of a scan with a transmission angle at an oblique angle to a surface of a film according to a possible implementation of the present disclosure.

FIG. 8 is a method for measuring a conductive metric of a film according to a possible implementation of the present disclosure.

FIG. 9 is a method for identifying a defect in the conductivity of a film according to a possible implementation of the present disclosure.

FIG. 10 is a method for characterizing a drying process according to a possible implementation of the present disclosure.

The components in the drawings are not necessarily to scale relative to each other. Like reference numerals designate corresponding parts throughout the several views.

### DETAILED DESCRIPTION

Lithium-ion batteries may operate based on thin films applied to a metal substrate. The thickness of the films may correspond to the energy density of the application, with higher energy-density applications using thicker films, while thinner films may be used for high-power applications with lower energy densities. In a possible implementation, the films can have a thickness in a range between 50 and 100 micrometers (i.e., microns). The films may be electrically lossy (i.e., absorptive). For example, a film for a cathode may have a conductivity in the range of 10 to 100 milli-Siemens (mS) per centimeter (cm) at millimeter-wave frequencies. Each thin film may be applied to a respective metal substrate as a wet combination of active material, binder, and solvent, which is then dried to form the film. Inconsistencies during the drying process (i.e., consolidation stage) may result in variations in the thickness and/or conductivity. For example, shrinkage may cause variations in the thickness of the film, while binder migration may cause variations in the conductivity. As a result, the resulting thin film may exhibit conductive heterogeneity (e.g., “hot spots”, “cold spots”, etc.) and/or non-uniform aging. A technical problem facing these conductive thin films is controlling these variations. Testing these properties during fabrication may be desired for this control, but in-line testing may not be possible without damaging or destroying the film. A system and method are disclosed to address, at least, this technical problem, with a non-destructive test that can characterize the electrical conductivity heterogeneity of the thin films before they are incorporated into a battery. A technical effect of these tests is improving the quality control of these thin films, which can make the manufacture of products, like the Li-ion battery, more efficient.

While the systems and methods disclosed herein are broadly applicable, the present disclosure focuses primarily on the inspection of lithium-ion battery electrodes. This implementation is emphasized because battery electrodes represent a critical and widely used technology that benefits significantly from the disclosed ability to continuously monitor internal electrical conductivity and drying states, which are otherwise difficult to characterize during manufacturing without destructive sampling.

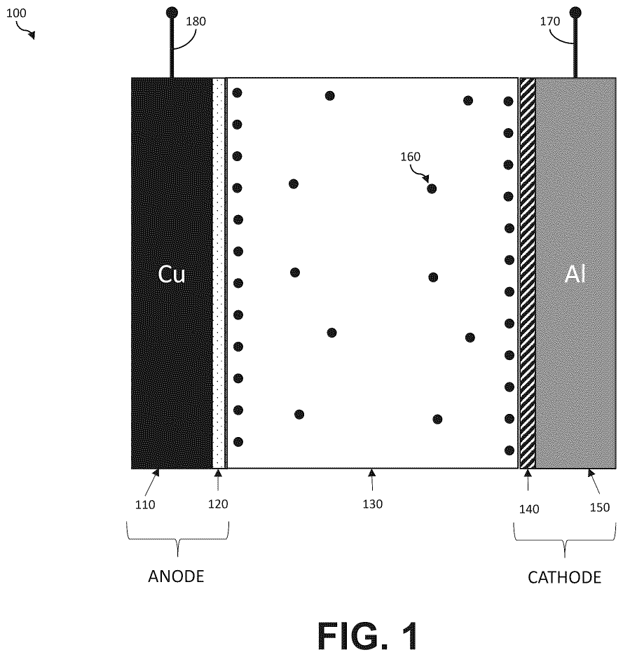

FIG. 1 is a schematic diagram of a lithium-ion (i.e., Li-ion) battery with thin films according to a possible implementation of the present disclosure. The Li-ion battery includes a first conductive substrate 110 (e.g., copper (Cu) substrate), which may function as a current collector for an anode electrode 180. The first conductive substrate 110 is coated with a first film 120 to form the anode of the Li-ion battery 100.

The first film 120 can include an active material (e.g., carbon black) in a polymer binder (e.g., poly(vinylidene fluoride) (PVDF)) to interact with lithium-ions 160 and conduct a current. To form the anode for the Li-ion battery 100, a solvent (e.g., methyl-2-pyrrolidinone (NMP)) may be used to create a slurry of the active material and the polymer. The slurry is deposited (e.g., spread) on the first conductive substrate 110. The slurry may then be dried (e.g., oven dried) for a period (e.g., ≤60 minutes) to solidify the first film 120.

The anode of the Li-ion battery 100 is laterally offset from a cathode of the Li-ion battery 100 by a separator/electrolyte 130, which is configured to conduct the lithium-ions 160 from the cathode to the anode when charging (and in an opposite direction when discharging). The cathode includes a second film 140 deposited on a second conductive substrate 150 (e.g., aluminum (Al) substrate), which may function as a current collector for a cathode electrode 170.

The second film 140 can include an active material (e.g., lithium cobalt oxide (i.e., LiCoO₂)) in the polymer binder (e.g., PVDF) to interact with the lithium-ions 160 and conduct the current. To form the cathode for the Li-ion battery 100, a solvent (e.g., NMP) may be used to create a slurry of the active material and polymer. The slurry is deposited (e.g., spread) on the second conductive substrate 150. The slurry may then be dried for a period (e.g., ≤60 minutes) to solidify the second film 140.

The conductivity of the first film 120 and the second film 140 may be approximately 100 milli-Siemens per centimeter (mS/cm). At this conductivity, a radar signal in a millimeter-wave portion of the electromagnetic spectrum (e.g., 40 gigahertz (GHz) to 80 GHz) can penetrate the film to a skin depth corresponding to a frequency of the radar signal. Accordingly, the frequency used to test a film can be selected based on a skin depth of the film at the frequency. In particular, the frequency used may be chosen so that its skin depth is greater than the thickness of the film so that the radar's transmit signal can penetrate the film and be reflected by the conductive substrate. If the skin depth is too small relative to the thickness, then the radar's transmit signal may not penetrate the film far enough to interact with the material and be reflected by the conductive substrate. For example, if the conductivity is too high (i.e., low absorption), then the radar's transmit signal may be reflected at a surface of the film without penetrating the film.

The interior microstructure (i.e., heterogeneity) of the first film 120 and the second film 140 can determine the electronic and ionic conductivity of the battery electrodes, which may correspond to the performance of the Li-ion battery 100, especially in fast charging or fast discharging conditions. As discussed, the manufacturing process for the film involves coating the electrode materials onto the conductive substrates, followed by a drying process to consolidate the film, and often a calendering step to compress the film to a desired porosity, which may introduce localized variations. Inconsistencies during the coating or drying process can lead to defects, such as a surface irregularity (i.e., external height heterogeneity) or an internal conductivity heterogeneity. For example, a non-uniform distribution of carbon black and binder within the film can create conductivity “hot spots”, which degrade battery performance. The disclosed system can inspect the anode and cathode (e.g., films) before they are assembled into a stack with the separator/electrolyte 130. The inspection may include mapping a “conductivity metric,” which corresponds to the conductivity of the film. The inspection may analyze the map and if it satisfies a criterion (e.g., is within a range), then the film may pass inspection. A film that fails inspection may, in some cases, trigger an adjustment to the manufacturing process.

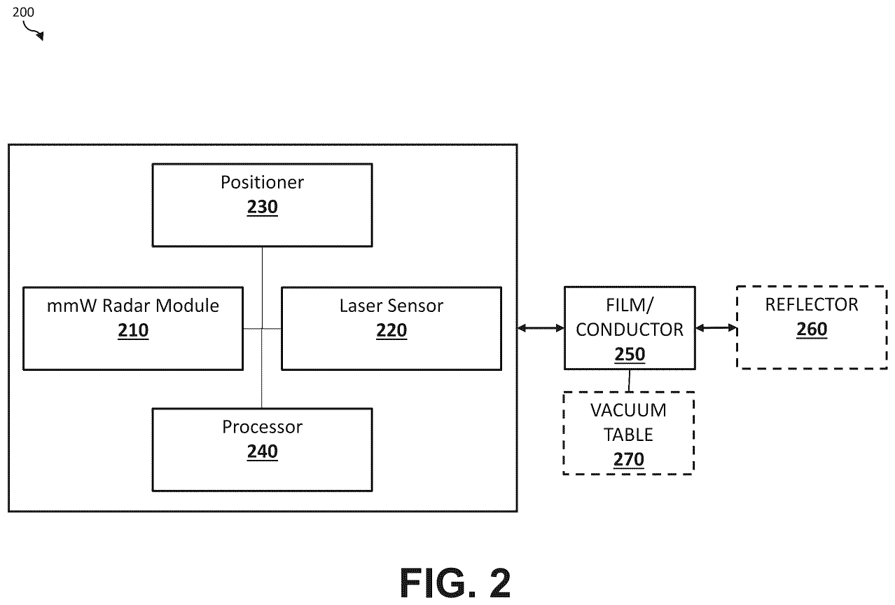

FIG. 2 is a schematic block diagram of a system for characterizing a film according to a possible implementation of the present disclosure. The system 200 is configured to inspect a film/conductor 250, such as the anode or cathode as shown in FIG. 1. The system 200 includes a millimeter-wave radar module 210 configured to transmit a transmit signal in a boresight direction to a test point on the film/conductor 250.

In a possible implementation, the millimeter-wave radar module 210 can be implemented as a frequency-modulated continuous-wave (FMCW) radar (e.g., Texas Instruments IWR6843). At each test point, the FMCW may be configured to sweep (i.e., chirp) through a frequency bandwidth of a few gigahertz (e.g., between 3 GHz and 5 GHz). The sweeping may allow for the return signal to be averaged over the bandwidth to provide more stability to the measurement. In other words, instead of relying on a single frequency, which might be susceptible to noise, the system 200 collects data from a test point at frequencies (e.g., all frequencies) in the frequency bandwidth (e.g., 3.2 GHz bandwidth) to compute the conductivity metric.

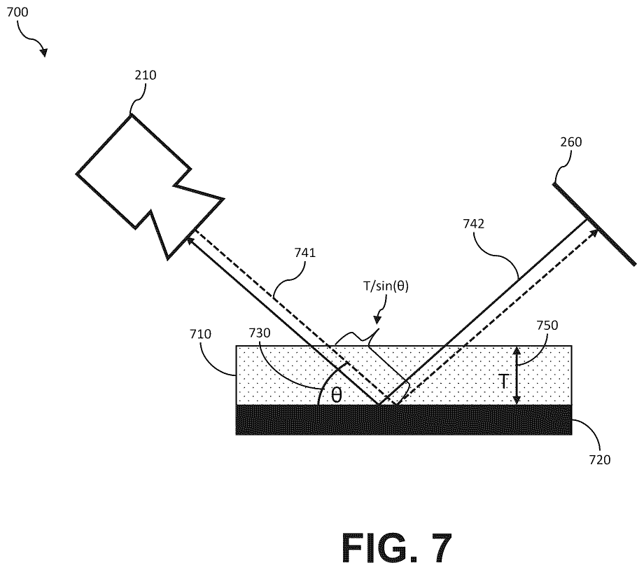

The system (i.e., processor 240) may be configured to apply a signal processing technique known as “range gating” (i.e., depth gating) to the processed data collected by the millimeter-wave radar module 210 to isolate the relevant return signals from background noise and clutter. Range gating uses the distance resolved by the frequency-modulated continuous-wave radar to accept return signals originating from within a window of ranges and reject (i.e., gate) other return signals. Additionally, azimuth gating can selectively accept return signals originating from the desired target area. This approach helps ensure that the computed conductivity metric corresponds to the film and is minimally affected by the surrounding environment (e.g., apparatus, floor, etc.). In other words, range (and azimuth) gating allows the system to effectively sample a “slice” of a target. In an off-axis configuration (see FIG. 7) range gating can be used to scan range and azimuth (i.e., angle) values to identify a signal path that has the highest return signal. This may reduce the time required to manually align the signal path.

The system 200 further includes a laser sensor 220 (e.g., Keyence LK-H052) mounted adjacent to the millimeter-wave radar module 210 and pointed in a direction aligned with the boresight direction of the millimeter-wave radar module 210. The laser sensor 220 is configured to measure a thickness of the film (i.e., film height) at the test point. For example, simultaneous to the millimeter-wave radar module 210 measuring a conductivity metric for a test point, the laser sensor 220 may measure a height of the test point. The laser sensor 220 can be offset from the millimeter-wave radar module 210 by a separation (e.g., 2 centimeters (cm)).

The millimeter-wave radar module 210 and the laser sensor 220 can be mounted to a positioner 230 configured to move the millimeter-wave radar module 210 and the laser sensor 220 over a film/conductor 250 to enable a scan (e.g., raster scan) of the film. In a possible implementation, the positioner 230 is an XYZ gantry (e.g., Carbide 3D) that moves the radar and laser head while the film remains stationary. Scanning the millimeter-wave radar module 210 and the laser sensor 220 over a surface of the film/conductor 250 creates a two-dimensional conductivity map and a two-dimensional topographic (i.e., height) map of the film surface. As will be discussed, the maps can be analyzed and compared to identify defects (e.g., defects, anomalies, irregularities, etc.) in the film, which do not conform with one or more criteria.

In some configurations, the system 200 may include a reflector 260, which can be implemented as an aluminum plate (e.g., polished aluminum). For example, the reflector 260 is included when the boresight direction of the millimeter-wave radar module 210 forms an oblique transmission angle with a surface (e.g., front surface) of the film/conductor 250. In this (oblique angle) configuration, the reflector 260 is required to redirect the transmit signal after it has passed through the film to generate a return signal at the millimeter-wave radar module 210. The reflector 260 is positioned to intercept the radar signal and angled to reflect it back along its original path to the millimeter-wave radar module 210. The reflector 260 is not required when the boresight direction is perpendicular to the surface of the film/conductor, because in this case, the conductive substrate functions as a retroreflector.

In a possible implementation, the system 200 further includes a vacuum table 270 configured to secure and flatten the film/conductor 250 during a scan. The vacuum table 270 may be configured to hold the film/conductor 250 against a surface (e.g., flat surface) by creating a low-pressure zone between the conductive substrate and the surface. The flatness provided by the vacuum table 270 may improve the scan results because even small ripples or surface irregularities in the film can cause significant artifacts in the return signal received by the millimeter-wave radar module 210.

The millimeter-wave radar module 210, laser sensor 220, and positioner 230 may be communicatively coupled to a processor 240 (e.g., a computer, controller, etc.). The processor 240 may be configured by software instructions (e.g., recalled from a non-transitory computer-readable medium) to perform a method for testing the film. The method can include controlling the positioner 230 to execute a scan pattern (e.g., raster pattern) over the surface of the film/conductor 250. The method can further include collecting return signals to map a conductivity metric (and height) of the film. The method can further include analyzing the conductivity metric to pass or fail the film based on quality criteria.

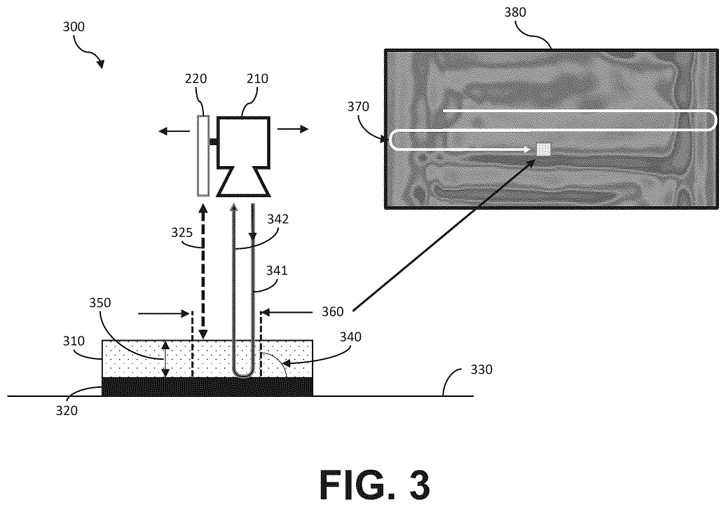

FIG. 3 is a side-view of a scan with a transmission angle perpendicular to a surface of a film according to a possible implementation of the present disclosure. The test system (i.e., system 300) directs a millimeter-wave radar module 210 and a laser sensor 220 towards a test point 360 on a film 310 deposited on a conductive substrate 320. To ensure accurate characterization (i.e., minimum interference), the conductive substrate 320 is secured against a vacuum table 330, which creates a low-pressure zone to maintain the conductive substrate 320 in a substantially planar orientation to minimize surface ripples. The radar module 210 is oriented with a boresight direction that defines a transmission angle 340 of approximately 90 degrees relative to the surface of the film 310. In other words, the millimeter-wave radar module 210 transmits the transmit signal 341 substantially perpendicular to a surface of the film 310.

As shown, the transmit signal 341 penetrates the film 310, reflects (i.e., retro-reflects) off the conductive substrate 320, and travels back through the film 310 to form a return signal 342. In other words, the return signal 342 is a retro-reflection of the transmit signal 341 after passing through the thickness 350 of the film two times.

The laser sensor 220 is configured to transmit light 325 to measure a physical thickness 350 of the material at the test point 360. The thickness 350 may be computed as a difference between (i) a first distance between the conductive substrate 320 (prior to the film 310 deposition) and the laser sensor 220 and (ii) a second distance between the film 310 and the laser sensor 220. Understanding the thickness 350 can allow computation of a conductivity metric for the test point 360 based on an attenuation of the return signal relative to the transmit signal and the thickness 350 of the film 310.

The system may include a positioner configured to move the millimeter-wave radar module 210 and laser sensor 220 in at least two dimensions over the film 310 along a scan path 370 to perform a scan. The scan may include collecting data (e.g., height data, attenuation data) at a plurality of test points. The processor may be configured to compute a conductivity metric based on a total reflection coefficient (I total), which includes the return loss (i.e., attenuation) of the return signal relative to the transmit signal. The processor associates the computed conductivity metrics with spatial coordinates (e.g., obtained from the positioner) to generate a two-dimensional conductivity map 380. As shown, the gray-scale pixels in the two-dimensional conductivity map 380 may correspond to the magnitudes of the conductive metrics collected during the scan. Pixel-to-pixel variations, which are above a threshold, can indicate a hot-spot defect (or cold-spot defect) which could negatively affect the performance of the film 310.

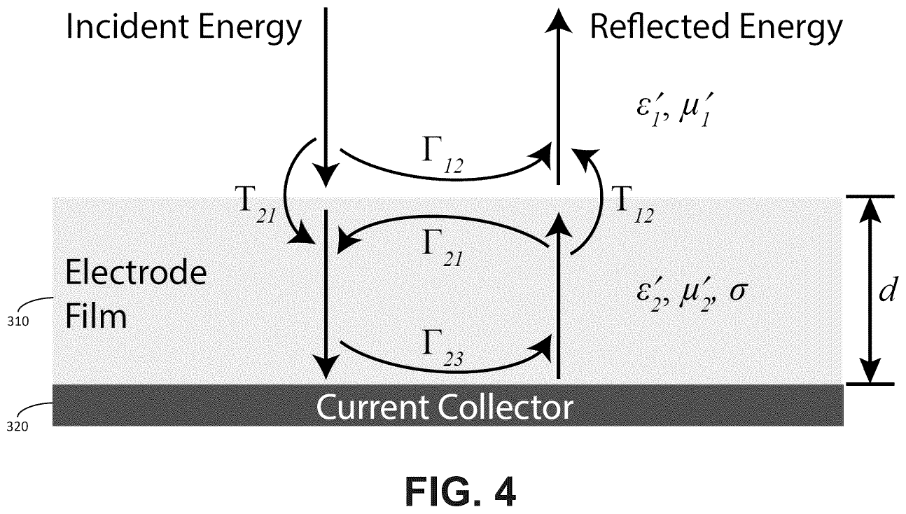

FIG. 4 is a side view of a film, illustrating various measurements regarding the transmit signal and the return signal, according to a possible implementation of the present disclosure. The diagram depicts the transmit signal 341 (i.e., Incident Energy) directed towards the film 310 (i.e., Electrode Film) having a thickness 350 (i.e., d) and having electromagnetic properties including permittivity (i.e., ε₂′), permeability (i.e., μ₂′), and conductivity (i.e., σ). This film 310 is disposed on a conductive substrate 320 (i.e., Current Collector), which acts as a reflector. The interactions are characterized by transmission coefficients (i.e., T₂₁, T₁₂) and reflection coefficients (Γ₁₂, Γ₂₁, Γ₂₃) at the boundaries, showing how electromagnetic energy penetrates the film 310, reflects internally, and exits as the return signal (i.e., Reflected Energy). The reflection coefficient at the front surface of the film (i.e., Γ₁₂) defines the reflection at the interface between the air (Region 1) and the film (Region 2) and is determined by the mismatch between the intrinsic impedance of the air and the intrinsic impedance of the film 310. The reflection coefficient at the conductive substrate (i.e., Γ₂₃) is equal to −1 when the conductive substrate 320 is assumed to be a perfect electrical conductor that reflects the signal entirely. The total reflection coefficient (i.e., Γₜₒₜₐₗ) represents an aggregate of these surface reflections, which result in the return signal. This total coefficient is mathematically defined as shown in Equation (1) below.

$${Γ}_{total} = \frac{{Γ}_{12} - {e}^{- j 2 θ}}{1 - {Γ}_{12} {e}^{- j 2 θ}} \qquad ( 1 )$$

In Equation (1), the term θ is a phase shift, which corresponds to the thickness (i.e., d) of the film 310. The total reflection coefficient (i.e., Γₜₒₜₐₗ) can be referred to as the “conductivity metric” because it corresponds to the conductivity (σ) of the film through the film's intrinsic impedance (η) and attenuation constant (α). When the film has an intermediate conductivity (i.e., between a perfect conductor and a perfect absorber), the film absorbs energy (i.e., attenuates energy). When the conductivity of the film is very high (e.g., infinite), the film behaves as a perfect conductor (i.e., |Γₜₒₜₐₗ|²=0 dB). As the conductivity is reduced, the film behaves more like an attenuator (i.e., |Γₜₒₜₐₗ|²<0 dB).

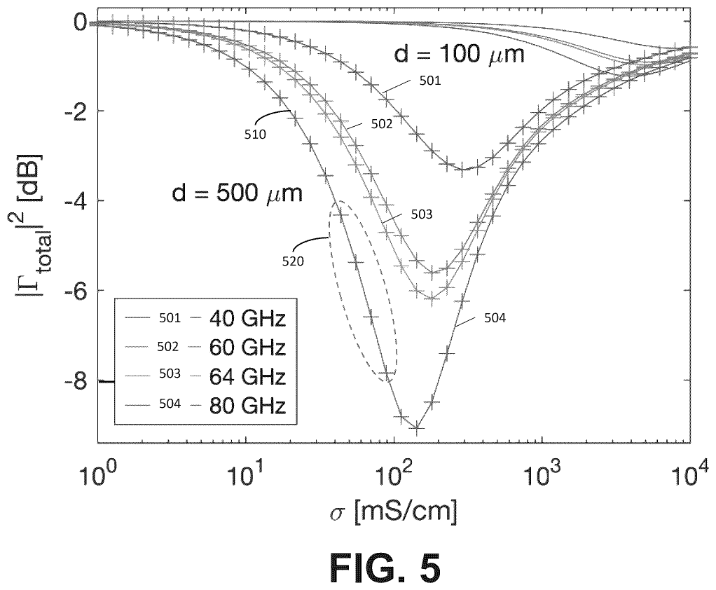

FIG. 5 is a graph illustrating how the conductivity metric relates to conductivity for different film thicknesses and for different frequencies according to possible implementations of the present disclosure. The graph plots the total reflection coefficient in decibels (dB) on the y-axis against the conductivity (mS/cm) on a logarithmic x-axis, showing distinct behaviors for films of d=100 μm (solid lines) versus d=500 μm (crossed lines).

As shown, the 80 GHz results for a 500 μm film (i.e., plot 510) exhibit a strong response. As shown, in a portion 520 of the plot 510, there is a substantially linear decrease of the total reflection coefficient (i.e., |Γₜₒₜₐₗ|²) from approximately −4 dB to −8 dB as the conductivity (i.e., σ) changes between roughly 40 mS/cm and 90 mS/cm. This demonstrates that the thickness and the frequency may be important factors to choose for sensing conductivity variations within a specific range. A frequency can be selected based on an expected thickness of the film and an expected conductivity range of the film. This selection may provide a sensor with a sensitive and linear response.

As can be further observed in FIG. 5, a thinner film (i.e., d=100 μm) at 40 GHz has a total reflection coefficient that is fairly constant at approximately 0 dB. These results may indicate that the film is too thin for sensing at this frequency because no significant interaction (i.e., attenuation) is possible at this thickness. In general, it may be advantageous to increase the interaction length (i.e., effective film thickness) to increase the sensitivity of the total reflection coefficient to conductivity changes.

As can be further observed in FIG. 5, the total reflection coefficient can decrease and then increase with increasing conductivity. This behavior can result from the interplay between absorption and surface reflection. At lower conductivities, the film allows the signal to penetrate, and as conductivity rises, the material becomes lossy, absorbing more energy and causing the return signal (and reflection coefficient) to decrease. However, as conductivity continues to rise, the impedance mismatch at the air-film interface increases and the skin depth decreases; eventually, the film becomes so conductive that it acts like a “metal sheet,” reflecting the energy entirely off the surface rather than allowing it to penetrate and be absorbed. This transition to surface reflection causes the total reflection coefficient to rise back toward 0 dB (perfect reflection) after reaching a minimum point of maximum absorption.

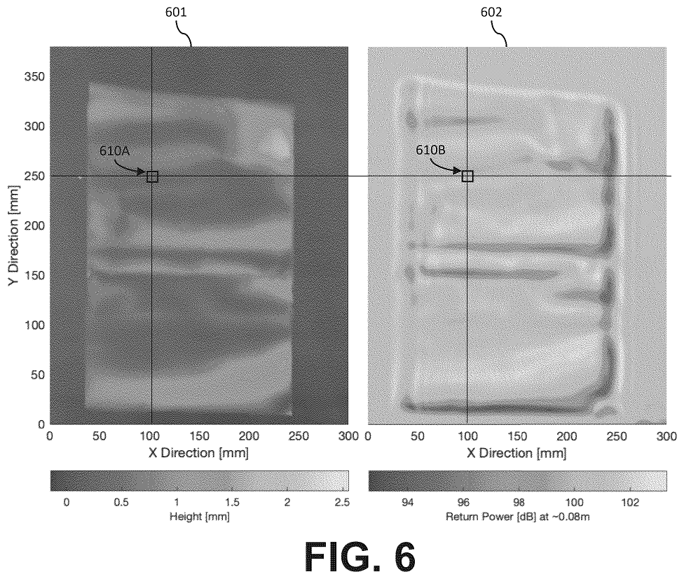

FIG. 6 illustrates a comparison of a two-dimensional topological map 601 and a two-dimensional conductivity map 602 according to a possible implementation of the present disclosure. The two-dimensional topological map 601 (shown on the left) is generated based on height data from the laser sensor received by a processor (e.g., after a scan). Each height in the height data may correspond to a distance between the laser sensor and a front surface of the film. The processor can determine a thickness from the height based on a reference distance. The reference distance can be the distance to a front surface of the conductive substrate prior to coating. As shown, the heights can be associated with the difference between the reference height and the height. Each height can be associated with a spatial coordinate (X (mm), Y (mm)), which can be obtained from the positioner, to generate a three-dimensional data set, which can be plotted as the two-dimensional topological map 601.

The two-dimensional conductivity map 602 (shown on the right) can include conductivity metrics determined based on attenuations. Each attenuation may be computed as the difference between the intensity of a return signal (i.e., return power) and the intensity of a transmit signal. Each conductivity metric can be associated with a spatial coordinate (X (mm), Y (mm)), which can be obtained from the positioner, to generate a three-dimensional data set, which can be plotted as the two-dimensional conductivity map 602.

Defects in the film can be classified by correlating test points in the maps by their location. As shown, a test point 610A on the two-dimensional topological map 601 and a corresponding test point 610B on the two-dimensional conductivity map 602 are correlated based on their common position in the film (i.e., 100 mm, 250 mm). Because the radar module and laser sensor are physically offset on the measurement head (e.g., by approximately 2 cm or 3 cm), the processor can digitally shift the data to ensure the test point 610A and the corresponding test point 610B represent the same physical location on the film. This alignment allows the system to check for corresponding physical features when an intensity change or local deviation indicates a defect or anomaly by satisfying a specific criterion (e.g., a decibel drop indicating an absorption change). For example, if a return power deviation in the two-dimensional conductivity map 602 has a corresponding height deviation in the two-dimensional topological map, then a defect may be identified at this location as a surface irregularity. Conversely, if a return power deviation in the two-dimensional conductivity map 602 does not have a corresponding height deviation in the two-dimensional topological map, then a defect may be identified at this location as an internal conductivity heterogeneity. This capability allows the system to detect non-visible defects, such as “hot spots” caused by inconsistent distribution of carbon black or binder, which degrade battery performance but cannot be detected by thickness measurements alone.

FIG. 7 is a side-view of a scan with a transmission angle at an oblique angle to a surface of a film according to a possible implementation of the present disclosure. The system 700 includes a film 710 (e.g., a battery electrode coating) having a thickness 750 (T) deposited on a conductive substrate 720 (e.g., an aluminum or copper current collector). A millimeter-wave radar module 210 directs a transmit signal 741 toward the film 710 such that the signal intercepts the surface at an oblique angle 730 (θ) rather than perpendicularly. The system further includes a reflector 260 (e.g., a polished aluminum plate) positioned to intercept the electromagnetic energy after it has interacted with the film.

This oblique angle configuration allows for two passes of the radar energy through the material. The transmit signal 741 passes through the film 710, reflects off the conductive substrate 720, and exits the film to strike the reflector 260. The reflector 260 redirects the energy back toward the film 710, causing it to pass through the film 710 and reflect off the conductive substrate 720 a second time before traveling back to the radar module as a return signal 742. This “double-pass” geometry significantly increases (e.g., 20 to 30 dB) the sensitivity of the system to changes in the conductivity of the film 710 compared to a single perpendicular pass.

The total interaction length is derived from the trigonometric relationship between the thickness 750 (T) and the oblique angle 730 (θ). In a perpendicular scan configuration (see FIG. 3) the radar signal travels a total distance of 2T (down and up) through the film. In the oblique scan configuration, the radar signal travels a first distance of 2T/sin(θ) in a transmit direction. The reflector 260 bounces the signal back through the material so that the radar signal travels a second distance of 2T/sin(θ) in a return direction. This double-pass approach effectively provides more material in the path of the radar signal.

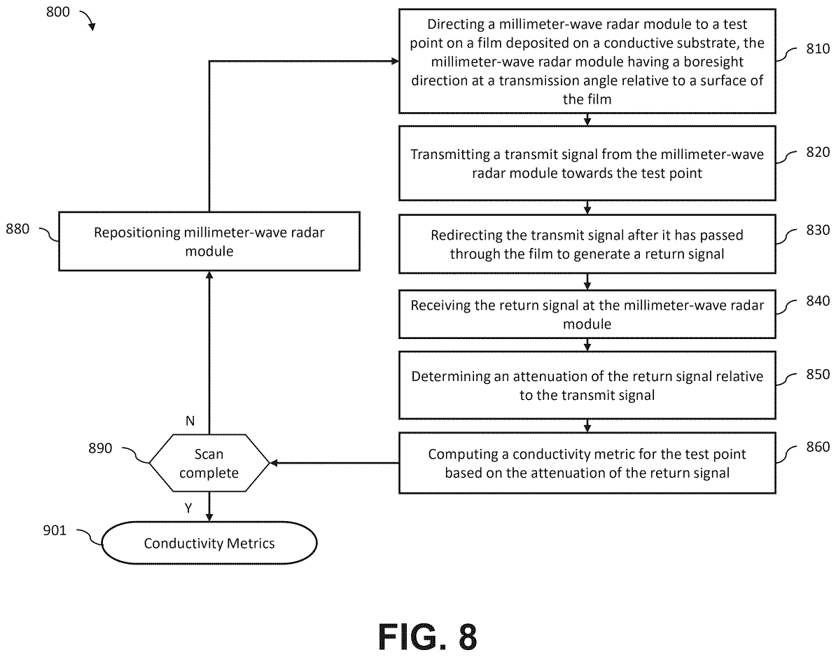

FIG. 8 illustrates a method for measuring a conductive metric of a film according to a possible implementation of the present disclosure. The method 800 begins with directing 810 a millimeter-wave radar module to a test point on a film deposited on a conductive substrate. The millimeter-wave radar module is oriented such that its boresight direction forms a transmission angle relative to the surface of the film, which may be approximately 90 degrees for a perpendicular scan (see FIG. 3) or between 20 and 45 degrees for an oblique scan (see FIG. 7) utilizing a reflector. The method 800 includes transmitting 820 a transmit signal from the mmW radar module towards the test point. In a possible implementation, the transmit signal is frequency-modulated to sweep a frequency of a frequency bandwidth.

The method 800 continues by redirecting 830 the transmit signal after it has passed through the film to generate a return signal. In the perpendicular arrangement, this redirection is accomplished by reflecting the signal off the conductive substrate functioning as a retroreflector. In the oblique arrangement, the radar signal passes through the film, reflects off the substrate, exits the film, and strikes a separate reflector which bounces the energy back through the film a second time. The method 800 then proceeds to receiving 840 the return signal at the millimeter-wave radar module and determining 850 an attenuation of the return signal relative to the transmit signal. Finally, the method 800 includes computing 860 a conductivity metric for the test point based on an attenuation. The attenuation may be related to a total reflection coefficient (I total) that accounts for the thickness of the film (e.g., measured simultaneously by a laser sensor) to isolate the specific conductivity (σ) of the material changes in thickness. If the scan is not complete (decision step 890), the method 800 includes repositioning 880 the millimeter-wave radar module (e.g., using an XYZ gantry) to a new test point and repeating the steps above. This process can repeat to collect a plurality of conductivity metrics 901, which can be associated with spatial coordinates to generate a 2D conductivity map of the film.

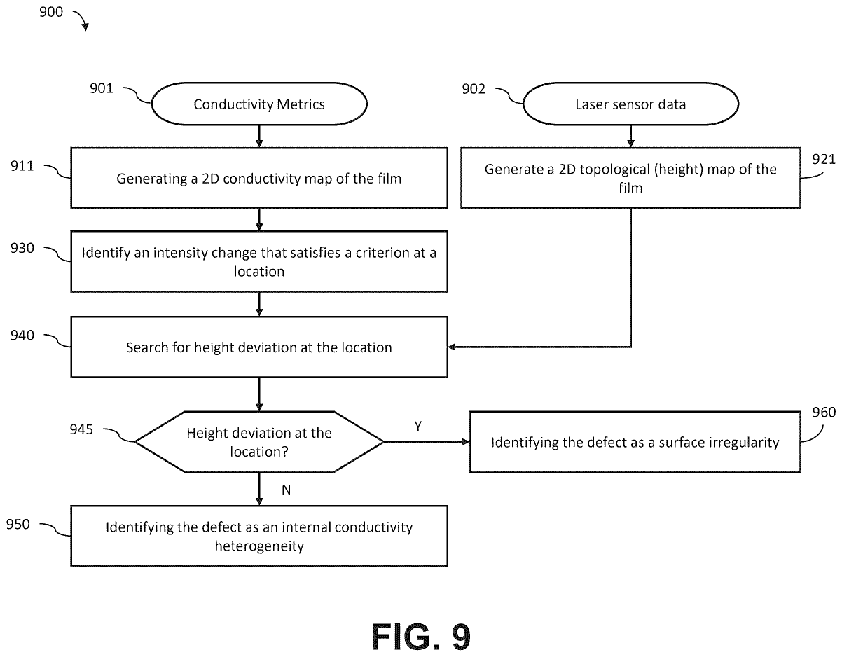

FIG. 9 illustrates a method 900 for identifying a defect in the conductivity of a film according to a possible implementation of the present disclosure. The method 900 begins by generating 911 a 2D conductivity map of the film using conductivity metrics 901 and generating 921 a 2D topological (height) map of the film using laser sensor data 902. The method 900 further includes identifying 930 an intensity change that satisfies a criterion at a location. In other words, locating a local deviation in the conductivity map that exceeds a threshold or matches a defect signature. Upon finding such a deviation, the method 900 proceeds to search 940 for height deviation in the topological map to determine if a physical anomaly (e.g., bump, wrinkle) exists at the corresponding spatial coordinate. The method 900 arrives at a decision block 945 asking if there is a height deviation at the location. If the answer is Yes (Y), the method 900 proceeds to identifying 960 the defect as a surface irregularity. This branch accounts for defects such as ripples, coating gaps, or physical damage that are visible in both the radar and laser data.

If the answer to the decision block is No (N), meaning the local deviation in the two-dimensional conductivity map does not have a corresponding deviation in the two-dimensional topological map, the method 900 proceeds to identifying 950 the defect as an internal conductivity heterogeneity. This branch is useful for detecting “hot spots” or inconsistencies in the distribution of active materials, which affect the electrical performance of the battery electrode but do not manifest as physical thickness changes detectable by the laser. This logic enables the system to differentiate between geometric surface defects and internal material quality issues.

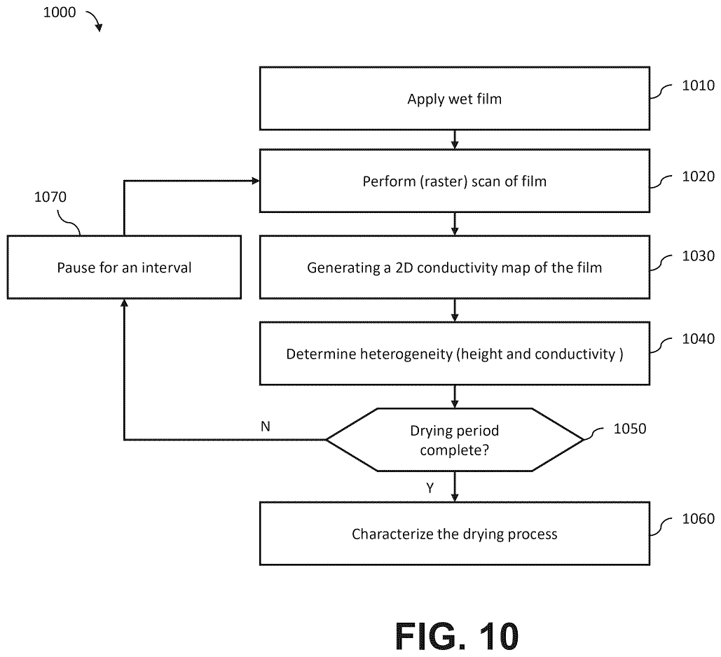

FIG. 10 illustrates a method 1000 for characterizing a drying process of a film according to a possible implementation of the present disclosure. The process begins with applying 1010 a wet film to a conductive substrate. In the experimental examples provided, this application includes applying a slurry of active materials (e.g., carbon black), binder (e.g., PVDF), and solvent (e.g., NMP) onto a copper current collector using a doctor blade or applying a paint analog using a pipette. Once the material is deposited, a scan is performed 1020 on the film. The scan may be repeatedly performed to characterize the evolution of the film's properties over time.

The characterization loop begins by performing 1020 a (raster) scan of the film using the millimeter-wave radar module and laser sensor to collect data across a designated area of the electrode surface. Using the return signals collected during this pass, the method 1000 includes generating 1030 a 2D conductivity map of the film, which captures the attenuation of the radar signal at a time point in a drying timeline. The method 1000 further includes analyzing the data to determine 1040 a heterogeneity in the film's thickness (height) and/or conductivity. This determination allows the system to detect phenomena such as “drying rate domains” where the rate of consolidation changes, or spatial non-uniformities where the film dries unevenly.

To create a time-series profile, the method collects multiple scans during a drying period. After each scan, the method 1000 evaluates 1050 whether the drying period is complete. If the answer is No (N), the method 1000 begins another scan after pausing 1070 for an interval. If the answer is Yes (Y), the method characterizes 1060 the drying process based on the comprehensive set of conductivity maps.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

Various implementations of the systems and techniques described here can be realized in digital electronic circuitry, integrated circuitry, specially designed ASICs (application-specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor and can be implemented in a high-level procedural and/or object-oriented programming language, and/or in assembly/machine language. As used herein, the terms “machine-readable medium” and “computer-readable medium” refer to any computer program product, apparatus, and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It will also be understood that when an element is referred to as being on, connected to, electrically connected to, coupled to, or electrically coupled to another element, it may be directly on, connected, or coupled to the other element, or one or more intervening elements may be present. In contrast, when an element is referred to as being directly on, directly connected to, or directly coupled to another element, there are no intervening elements present. Although the terms directly on, directly connected to, or directly coupled to may not be used throughout the detailed description, elements that are shown as being directly on, directly connected, or directly coupled can be referred to as such. The claims of the application may be amended to recite example relationships described in the specification or shown in the figures.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

It will be understood that, in the foregoing description, when an element is referred to as being on, connected to, electrically connected to, coupled to, or electrically coupled to another element, it may be directly on, connected, or coupled to the other element, or one or more intervening elements may be present. In contrast, when an element is referred to as being directly on, directly connected to, or directly coupled to another element, there are no intervening elements present. Although the terms directly on, directly connected to, or directly coupled to may not be used throughout the detailed description, elements that are shown as being directly on, directly connected, or directly coupled can be referred to as such. The claims of the application, if any, may be amended to recite exemplary relationships described in the specification or shown in the figures.

1. A method comprising:
directing a millimeter-wave radar module to a test point on a film deposited on a conductive substrate, the millimeter-wave radar module having a boresight direction at a transmission angle relative to a surface of the film;
transmitting a transmit signal from the millimeter-wave radar module towards the test point;
redirecting the transmit signal after it has passed through the film to generate a return signal;
receiving the return signal at the millimeter-wave radar module;
determining an attenuation of the return signal relative to the transmit signal; and
computing a conductivity metric for the test point based on the attenuation of the return signal.

2. The method according to claim 1, further comprising:
collecting a plurality of conductivity metrics at a plurality of corresponding test points on the film, wherein the millimeter-wave radar module is repositioned by a positioner between each collection.

3. The method according to claim 2, further comprising:
associating the computed conductivity metric for each test point with a spatial coordinate of each test point to generate a two-dimensional conductivity map.

4. The method according to claim 3, further comprising:
correlating the two-dimensional conductivity map with a two-dimensional topological map of the film generated by a laser sensor; and
identifying a defect as a surface irregularity when a local deviation in the two-dimensional conductivity map has a corresponding deviation in the two-dimensional topological map.

5. The method according to claim 4, further comprising:
identifying the defect as a conductivity heterogeneity internal to the film when the local deviation in the two-dimensional conductivity map does not have the corresponding deviation in the two-dimensional topological map.

6. The method according to claim 2, further comprising:
selecting a frequency for the transmit signal so that a skin depth of the film at the frequency is greater than a thickness of the film.

7. The method according to claim 1, wherein the transmit signal has a frequency that is swept over a frequency bandwidth so that each conductivity metric computed is averaged over the bandwidth.

8. The method according to claim 1, wherein the transmission angle is approximately 90 degrees and redirecting the transmit signal includes:
reflecting the transmit signal off the conductive substrate after the transmit signal has passed through the film.

9. The method according to claim 1, wherein the transmission angle is between 20 degrees and 45 degrees and redirecting the transmit signal includes:
reflecting the transmit signal off a reflector positioned to intercept the transmit signal after the transmit signal has passed through the film.

10. The method according to claim 9, wherein the reflector is oriented to direct the return signal towards the test point, so that both the transmit signal and the return signal pass through the film at the test point.

11. The method according to claim 2, further comprising:
recollecting the plurality of conductivity metrics from the plurality of corresponding test points over time to monitor a drying process of the film.

12. A system comprising:
a film disposed on a conductive substrate;
a millimeter-wave radar module configured to:
transmit a transmit signal towards the film, the transmit signal passing through the film at a test point and being redirected back to the millimeter-wave radar module as a return signal; and
receive the return signal from the test point;
a laser sensor configured to measure a thickness of the film at the test point; and
a processor communicatively coupled to the millimeter-wave radar module and the laser sensor, the processor configured by software instructions to:
determine an attenuation of the return signal relative to the transmit signal; and
compute a conductivity metric for the test point based on the attenuation and the thickness of the film at the test point.

13. The system according to claim 12, further comprising a positioner configured to point the millimeter-wave radar module at a plurality of test points on the film, the processor further configured to:
collect a plurality of return signals from the plurality of test points;
compute conductivity metrics for the plurality of test points, and
associate the computed conductivity metrics with spatial coordinates obtained from the positioner for the plurality of test points to generate a two-dimensional conductivity map of the film.

14. The system according to claim 13, wherein the laser sensor is mounted adjacent to the millimeter-wave radar module on the positioner, and the processor further configured to:
generate a two-dimensional topological map of the film based on data from the laser sensor;
identify a defect and an intensity change in the two-dimensional conductivity map that satisfies a criterion; and
determine that the defect is an internal conductivity heterogeneity when the intensity change does not have a corresponding height deviation in the two-dimensional topological map.

15. The system according to claim 12, wherein the millimeter-wave radar module transmits the transmit signal perpendicular to a surface of the film, and the conductive substrate is configured to retro-reflect the transmit signal to generate the return signal.

16. The system according to claim 12, wherein the millimeter-wave radar module transmits the transmit signal at an oblique angle relative to a surface of the film, the system further comprising a reflector configured to:
receive the transmit signal after it has passed through the film and been reflected by the conductive substrate; and
reflect the transmit signal to generate the return signal, the reflector positioned so that the return signal passes through the film a second time at the oblique angle before being reflected by the conductive substrate and received at the millimeter-wave radar module.

17. The system according to claim 12, wherein the millimeter-wave radar module is configured to transmit the transmit signal in a vertical polarization in a vertical plane orthogonal to a horizontal plane of the film to minimize a spread of the transmit signal in the vertical plane.

18. The system according to claim 12, wherein:
the millimeter-wave radar module is a frequency-modulated-continuous-wave radar module configured to sweep the transmit signal over a frequency bandwidth; and
the processor is configured to average an intensity of the return signal over the frequency bandwidth.

19. The system according to claim 18, wherein:
a frequency of the transmit signal is in a first range between 60 gigahertz and 64 gigahertz or is in a second range between 77 gigahertz and 81 gigahertz; and
the frequency bandwidth of the transmit signal is between 3 gigahertz and 4 gigahertz.

20. The system according to claim 12, further comprising a vacuum table configured to hold the film deposited on the conductive substrate against a surface by creating a low-pressure zone between the conductive substrate and the surface.
